(19) United States
(12) Patent Application Publication
(10) Pub. No.: US 2014/0326838 A1
(43) Pub. Date: Nov. 6, 2014

(54) Apparatus, System, and Method for Photovoltaic-Related Wire Management

(71) Applicants: John Raymond West, San Rafael, CA (US); Brian West, San Rafael, CA (US)

(72) Inventors: John Raymond West, San Rafael, CA (US); Brian West, San Rafael, CA (US)

(73) Assignee: ZEP SOLAR, INC., San Rafael, CA (US)

(21) Appl. No.: 14/194,607

(22) Filed: Feb. 28, 2014

Related U.S. Application Data
(63) Continuation-in-part of application No. 13/961,723, filed on Aug. 7, 2013.
Application No. 13/961,723 is a continuation-in-part of application No. 13/961,662, filed on Aug. 7, 2013.
Application No. 13/961,662 is a continuation-in-part of application No. 14/106,153, filed on Dec. 13, 2013.
(60) Provisional application No. 61/771,050, filed on Feb. 28, 2013.

(51) Int. Cl. F16L 3/04; F16L 3/10

(52) U.S. Cl. CPC F16L 3/04; F16L 3/1058
USPC 248/74.2; 29/453

(57) ABSTRACT

A flexible wire clip dimensioned to be snapped into a side groove on a photovoltaic module frame, wherein the wire clip flexes during installation such that a catch moves away from a frame-receiving slot and slides upwardly against a side edge of a photovoltaic module frame so that a frame member of a photovoltaic module frame can be inserted into the frame-receiving slot, and wherein the wire clip returns to a substantially non-flexed position after it has been snapped into the side groove of a photovoltaic module frame.

### RELATED APPLICATIONS

The present invention claims priority to U.S. Provisional Patent Application Ser. No. 61/771,050, of same title, filed Feb. 28, 2013.

The present invention is a continuation-in-part of U.S. patent application Ser. Nos. 13/961,723 and 13/961,662, both filed Aug. 7, 2013, entitled “Method And Apparatus For Forming And Mounting A Photovoltaic Array”.

The present invention also is a continuation-in-part of U.S. patent application Ser. No. 14/106,153, filed Dec. 12, 2013, entitled “Connecting Components For Photovoltaic Arrays”.

### TECHNICAL FIELD

The present invention relates to wire clip systems for photovoltaic (PV) modules.

### BACKGROUND OF THE INVENTION

PV modules and related mounting hardware are well known and in widespread use for, among other things, the production of electrical energy from solar radiation. PV modules generally include at least two output wires for transmission of electrical energy. As PV modules are installed and their output wires connected to the wires of other PV modules or ancillary devices, those wires must be secured and organized to facilitate installation and to prevent drooping, tangling, disconnection, and other hazards. A wire clip may position, secure, organize, and orient those wires by arranging the wires along or in a designated orientation to a frame body, other wires, another ancillary device, or a combination of the foregoing.

Various wire management systems and devices for PV module wires have been disclosed and shown in Published U.S. Patent Applications: 2012/0260972; 2012/0279558; 2012/0255598 and 2012/0298186, each of which is entitled: “Method and Apparatus for Forming and Mounting a Photovoltaic Array”. Each of these patent applications are incorporated by reference herein in their entirety, as well as others. Other ancillary embodiments, including otherwise related or associated apparatus(es), system(s) and method(s) regarding embodiments of wire clip and other components have similarly been disclosed by applications of at least one of the named inventors hereto.

The above systems all provide effective wire management. However, what is desired is a wire management system that readily permits a wire clip to be quickly and easily installed at any desired position along the side groove in a PV module frame. Such a system would be quickly and easily positionable at any desired location, and also be easily removable. Ideally, such a system would also hold a plurality of wires and be able to hold such wires at different angles and orientations. As will be shown, the present system provides these benefits and offers additional advantages.

### Terms:

While various terms may have their ordinary meaning or particular meaning in the art, for ease of understanding there is provided herein, both below and at other locations in this specification, a non-limiting explanation as to the minimum scope intended for understanding of the present specification. Terms may be in singular or plural or any tense while retaining the same general meaning.

The term “channel” or “groove” refers to a device, item, feature or portion of an item that refers to a long, narrow cut, rut, indentation, channel, female portion, trench, furrow, gutter, slot or depression often used to guide motion or receive a corresponding male portion, ridge or tongue. An example groove is shown at groove 211 in the PV module frame of FIG. 2A, and its descriptions.

The term “engage” refers to contacting, interlocking or meshing one or more items, mechanisms, objects, things, structures or the like and “disengage” refers to detaching, freeing, loosening, extricating, separating or releasing from something that holds-fast, connects, couples or entangles. An example where one item engages another is shown and disclosed at wire clip 201 in FIG. 2A, which engages groove 211.

The term “guide” refers to a structure that organizes, directs, or orients one or more items, mechanisms, objects, things, structures, or the like. An example guide is shown and disclosed at wire clip 201 in FIG. 2A.

The term “wire clip” generally refers to a structure with two or more connectors, where at least one connector connects the wire clip to one wire or a series of wires, and at lest one connector connects the wire clip to something else. An example wire clip is shown at wire clip 101 in FIG. 1, and its descriptions.

The term “flexible portion” refers to a part, segment or portion of a device or feature that is capable of bending or deforming easily, such as made with a supple, pliable, pliant, or elastic material. For example, an arm of a wire clip may flex as the wire clip connects to a frame as exemplified in FIGS. 2A and 3.

The term “opening” refers to something that is open, as breach, aperture; an open width or span; an open space serving as a passage or gap; a breach or aperture; a vacant or unobstructed space, such as one that will serve as a passageway; and/or a gap. Openings, without limitation, are exemplified at parts 108a, 108b and 108c in FIG. 1.

The term “catch” refers to any form of hook, latch, snap-connector, clasp, clamp, tie, or snare, as exemplified by part 105 in FIG. 1.

### SUMMARY OF THE INVENTION

In preferred aspects, the present system provides a flexible wire clip dimensioned to be attached into a side groove on a photovoltaic module frame, comprising: (a) a first portion; (b) a frame-receiving slot at a first end of the first portion; (c) a brace extending upwardly from the first portion; (d) a wire gather on the first portion; (e) a second portion extending upwardly from a second end of the first portion; and (f) a catch at an end of the second portion.

During installation, the wire clip flexes such that the catch is pulled away from the frame-receiving slot so that a portion of a photovoltaic module frame can be inserted into the frame-receiving slot. At this time, the brace is positioned against a bottom surface of the photovoltaic module frame, and the catch is slid upwardly against a side edge of the photovoltaic module frame until the wire clip returns to a substantially non-flexed (installed) position with the catch received within a side groove on a photovoltaic module frame.

In alternate aspect, the brace is omitted and the first portion has a downwardly curved section that both acts as a trigger for the operator's finger, and also assists in the flexing of the clip.

Advantageously, the present system can be quickly and easily “snapped” or “clicked” into a locked position simply by applying a force from below. In this regard, the wire clip flexes or deforms during installation such that it can be received around the bottom and side edges of the PV module frame (prior to installation) and then gently pushed upwards such that an upper catch slides up the side edge of the frame and then snaps into a side groove in the PV module frame.

As such, an advantage of the present system is that the snap action is preferably audible. Thus, an operator installing the wire clips hears them snap into place. This is especially desirable since it helps the installer know that the clip is properly seated, even if it is difficult to see the clip placement (such when working in small spaces between adjacent PV modules).

Yet another advantage of the present system is that it can be used to hold different wires at 90 degree angles to one another. This is beneficial since many solar panel installations have wires running in both north-south and east-west directions.

Optionally, the first portion is curved downwardly to form a trigger and the second portion extends upwardly from the end of the first portion at an acute angle.

An advantage of the system is that the wire gather may optionally be positioned above the frame-receiving slot such that a wire received therein is positioned above a bottom surface of the photovoltaic module frame. This saves space as the wires need not hang below the photovoltaic module frame at these locations.

Further advantages of the present wire clip is that does not require tools to install, does not have sharp edges near wire holding features, and is very intuitive to use. Additional advantages include the wire clips not sliding along the PV module frame when the wires they are supporting are pulled during system installation. Moreover, the wire(s) can easily be removed after the PV modules are installed if desired.

Optionally included as well is the method of clipping a wire clip into a side groove on a photovoltaic module frame, by: (a) providing a wire clip having: (i) a first portion; (ii) a frame-receiving slot at a first end of the first portion; (iii) a brace extending upwardly from the first portion; (iv) a wire gather on the first portion; (v) a second portion extending upwardly from a second end of the first portion; and (vi) a catch at an end of the second portion; (b) inserting a frame member of a photovoltaic module frame into the frame-receiving slot; (c) positioning the brace against a bottom surface of the frame member; and (d) applying a force to the bottom of the first portion, thereby causing the wire clip to flex such that the catch slides upwardly against a side edge of the photovoltaic module frame until the catch snaps into a side groove on a photovoltaic module frame and the wire clip returns to a substantially non-flexed position.

### BRIEF DESCRIPTION OF THE DRAWINGS

FIG. 1 is a perspective view of a first embodiment of a wire clip.

FIG. 2A is a side elevation view of the wire clip of FIG. 1.

FIG. 2B is a perspective view of the wire clip of FIGS. 1 and 2A as mounted onto a frame member.

FIG. 3 is a view similar to FIG. 2A, but adding the wires held by the wire clip.

FIG. 4 is a perspective view of a second embodiment of the wire clip.

FIG. 5 is a perspective view of a third embodiment of the wire clip.

FIG. 6 is a perspective view of a fourth embodiment of the wire clip.

FIG. 7A is a perspective view of a fifth embodiment of a wire clip.

FIG. 7B is a view similar to FIG. 7A, with a wire received therein.

FIG. 8A is a perspective view of a sixth embodiment of the wire clip.

FIG. 8B is a view similar to FIG. 8A, but adding a pair of wires.

FIG. 8C is a side elevation view corresponding to FIG. 8B.

FIG. 8D is a side elevation view of the wire clip of FIG. 8A, prior to attachment to a PV module frame.

FIG. 8E is a side elevation view of the wire clip of FIG. 8A, after to attachment to a PV module frame.

FIG. 9 is a perspective view of a seventh embodiment of the wire clip.

FIG. 10 is a perspective view of an eighth embodiment of the wire clip.

FIG. 11A is a perspective view of a ninth embodiment of the wire clip, which is ideally suited for use as an underside wire clip.

FIG. 11B is a side elevation view of the embodiment of FIG. 11A installed on a PV module frame.

FIG. 12A is a perspective view of a first embodiment of a wire bundle clip.

FIG. 12B is a side elevation view of the embodiment of FIG. 12A installed on a PV module frame.

FIG. 13A is a second embodiment of a wire bundle clip.

FIG. 13B is a side elevation view of the embodiment of FIG. 12A installed on a PV module frame.

FIG. 14A is a third embodiment of a wire bundle clip.

FIG. 14B is a side elevation view corresponding to FIG. 14A.

FIG. 15A is a perspective view of a fourth embodiment of a wire bundle clip.

FIG. 15B is a side elevation view corresponding to FIG. 15A.

FIG. 16A is a perspective view of pest abatement wire clip.

FIG. 16B is a side elevation view corresponding to FIG. 16A.

FIG. 17A is an illustration of the wire clip prior to installation.

FIG. 17B is an illustration of the wire clip during installation.

FIG. 17C is an illustration of the wire clip after installation. Together, FIGS. 17A to 17C show the wire clip being snapped into position.

### DETAILED DESCRIPTION OF THE DRAWINGS

Referring now to embodiments shown in the figures, wherein like numerals refer to like structures, embodiments of a wire clip are shown.

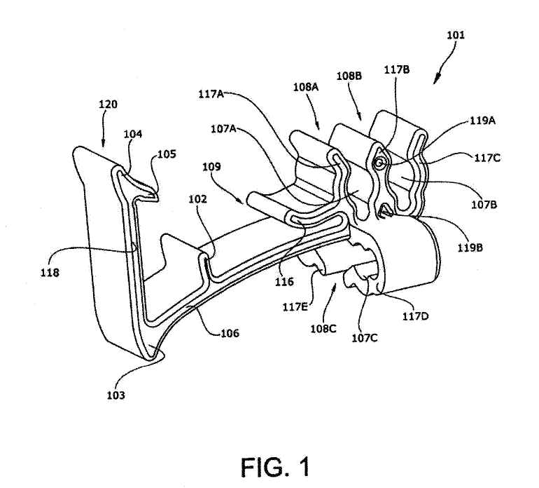

Referring first to FIG. 1, a wire clip, such as wire clip 101, may include a first portion (i.e.: arm) 106 having a brace 102 (extending upwardly from a mid-section of arm 106), a trigger 103 (extending downwardly from a proximal end of first portion 106), a tab 104 at a distal end of second portion 118 (extending upwardly from a proximal end of arm 106) having a catch 105 (at the distal end of second portion 118) as shown and described regarding FIG. 1 and further described as follows.

Brace 102 which extends vertically from arm 106 and serves as a fulcrum over which the arm 106 flexes or otherwise deforms to engage a PV module frame such as a side groove in the frame, as described more fully below. Trigger 103 may be formed at or near the intersection of the first portion 106 and second portion 118, and may appear as a downward concave curve extending from the first portion 106 that then rises as a convex upward curve toward the second portion 118, or may take a different form. A tab 104 may extend from the top of the second portion 118 such that it rises up and away from catch 105. A catch 105 may extend from second portion 118 at an angle of less than ninety degrees. Inner surface 120 may be the surface of second portion 118 on which catch 105 is positioned. Catch 105 faces the frame-receiving slot 109.

Prior to the wire clip flexing, catch 105 is located as shown in FIG. 1. When a force is applied to the wire clip, it will flex such that catch 105 will move farther away from slot 109. When the force is released, catch 105 will then move back towards slot 109. As such, when the wire clip is flexed, an edge surface of the PV module frame can be received in slot 109. When the force is released, catch 105 can then spring back into position within a side groove in the PV module frame, clipping the wire clip into a secure position on the frame.

Wire clip 101 may further include a flange 116, one or more gathers 117A-117E (at a distal end of first portion 106), any of which may include one or more eyelets such as eyelets 119A-119B, a second portion 118, and one or more wire channels 107a, 107b and 107c with apertures 108a, 108b and 108c, as also shown in FIG. 1 and further described as follows. First portion 106 may extend from the trigger 103 to the opposite end of the wire clip 101 containing the gathers 117A-117E. First portion 106 may be able to flex or otherwise deform to enable engagement with a groove in the PV frame, as described more fully herein.

Wire channel 107A-107C is the space formed between gathers 117A-117E. Wire channel 107A-107C may hold and orient cables, as described more fully below, and may hold one or more cables. A wire channel 107A-107C may be parallel to first portion 106, perpendicular to the first portion 106, or be formed at some other angle with respect to first portion 106. An aperture 108A-108C may be the space formed between and at the outward ends of the gathers 117A-117E. Wires may enter the wire channel 107A-107E through apertures 108A-108C, as discussed more fully below. A frame-receiving slot 109 may be the space formed between the first portion 106 and the flange 116. The ledge of a PV module frame may enter the slot 109 when a wire clip 101 connects to a groove, as discussed more fully below. A flange 116 may extend from the wire clip 101 near the gathers 117A-117E above the first portion 106 and toward the second portion 118. A gather 117A-117E may extend up or down from the first portion 106, may be curved or linear, and may be oriented parallel to, perpendicular to, or at an angle to first portion 106. A gather such as gather 117B may be formed with one or more eyelets 119A-119B. Gathers 117A-117E may flex or otherwise deform to permit a wire or similar component to enter the wire channel 107A-107C through the aperture 108A-108C, as discussed more fully below. Eyelets 119A-119B may be the space formed in the hollow portions of a gather such as gather 117B.

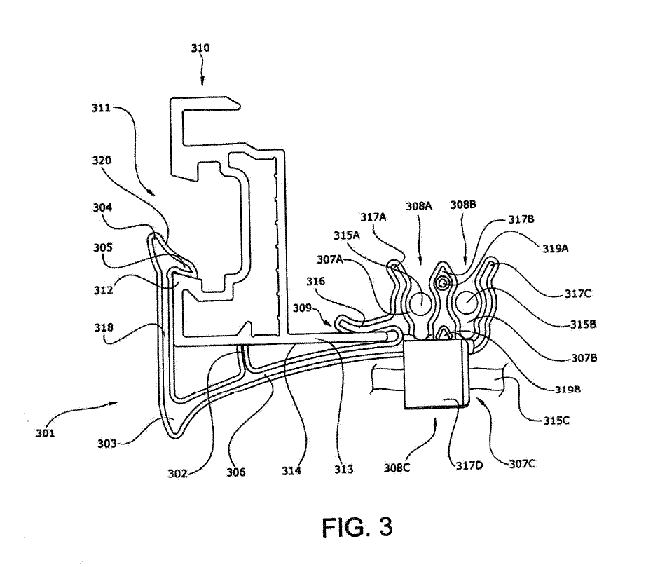

Second portion 118 may extend vertically from the trigger 103 to the tab 104 and catch 105. Second portion 118 may flex or otherwise deform to enable engagement with a groove in a frame member of a PV module, as described more fully below. Wire clip 101 may be fabricated or constructed from various materials, such as plastic, metal, or another non-conductive or conductive material(s). One advantage of using plastic embodiments, is that plastic wire clips need not be grounded. A wire clip embodiment constructed or fabricated with conductive material(s) may include teeth, grips, tabs, hooks, or other components that cut, puncture, or otherwise pierce the surface of a frame to provide a grounded connection between the wire hook and the frame. Eyelets such as eyelets 119A-119B may be used to maintain a uniform thickness of material in various embodiments of a wire clip 101. Various embodiments of wire clip(s) may hold wires or the like in more than one orientation, for example the embodiments of FIG. 3 show wires held both parallel and perpendicular to the frame member, at two vertical levels. However, various other embodiments are hereby explicitly disclosed including two or more sets of wires or the like oriented at various degrees of deflection from the length of the frame, such as 5-15 degrees, 15-30 degrees, 30-45 degrees, 45-60 degrees, 60-75 degrees, 75-90 degrees or 90-180 degrees. Wires may also be held at different vertical levels; for instance FIG. 3 shows wires held at two vertical levels.

Other embodiments are hereby explicitly disclosed including embodiments with two, three, four, or more levels of wire channels which may be above or below the frame member, or a combination of the two; such different vertical levels may also hold wires at various orientations. Other embodiments are hereby explicitly disclosed including embodiments with one, two, three, four, five or more wire channels, where panels or wire clips may extend in the same direction or different directions, appear in one level or multiple levels, and consist of the same substance(s) or different substances.

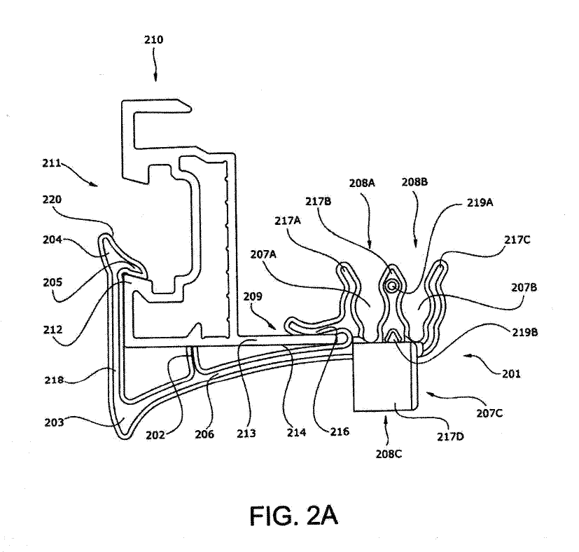

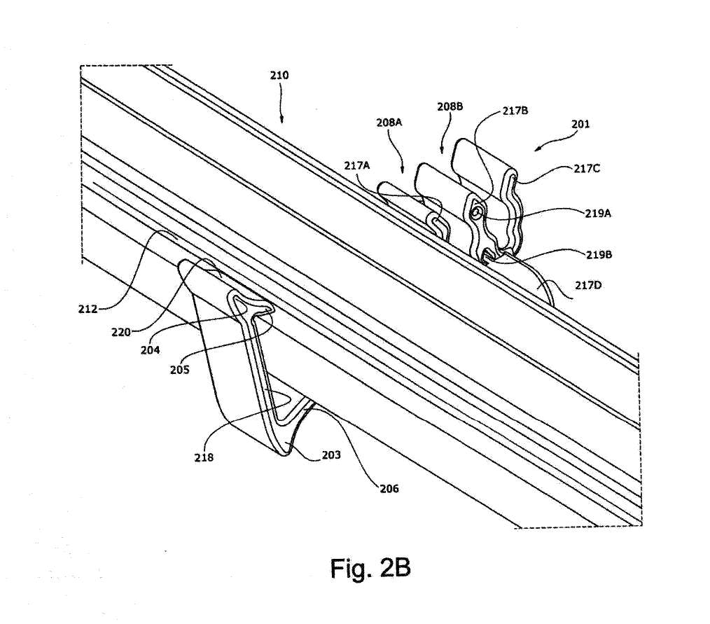

Referring now to FIG. 2A, a cut away side elevation view of a wire clip such as wire clip 201 is shown, connecting to a PV module frame such as frame 210. Wire clip 201 may be similar to wire clip 101 as shown and described regarding FIG. 1 and others. Wire clip 201 may similarly include a brace 202, a trigger 203, a tab 204, and a catch 205 with an inner surface 220 as shown and described regarding FIG. 2A. Wire clip 201 may further include a first portion 206, a frame-receiving slot 209 a flange 216, two or more gathers 217A-217E, a second portion 218, and one or more wire channels 207A-207C with apertures 208A-208C, as also shown in FIG. 2A. Furthermore, all as shown and described regarding FIG. 1 and others, brace 202 may be similar to brace 102, trigger 203 may be similar to trigger 103, tab 204 may be like tab 104, catch 205 may be like catch 105, arm 206 may be similar to catch 106, wire channel 207A-207C may be similar to wire channel 107A-107C, aperture 208A-208C may be similar to aperture 108A-108C, slot 209 may be similar to slot 109, flange 216 may be similar to flange 116, gather 217A-217E may be similar to gather 117A-117E, eyelet 219A-219B may be like eyelet 119A-119B, and second portion 218 may be similar to second portion 118.

PV module frame 210 may have (i) a groove such as groove 211 with a lower lip such as lower lip 212, (ii) a bottom ledge such as ledge 213, and (iii) an underside such as underside 214. As shown in FIG. 2A, a wire clip 201 may be partially inserted into and may lock into groove 211 of frame 210. Wire clip 201 may also engage groove 211 as shown in FIG. 2A. Wire clip 201 may act as a guide to orient a wire or other cable-like material, as would be understood by one of skill in the art, along a frame or among frames, as discussed above and further discussed below. Wire clip 201 may connect to frame 211 as follows. Ledge 213 may enter slot such 209. Ledge 213 may or may not contact the end of the slot 209 depending on various dimensions as would be known to one with skill in the art. Brace 202 contacts underside 214.

In operation, wire clip 201 is flexed to be latched into groove 211 as follows. First, trigger 203 is pulled or pushed away from slot 209 and upwards (i.e.: trigger 203 is pulled away from the distal end of arm 106). The pulling force against trigger 203 may cause first portion 206 to bend or otherwise deform around the end of brace 202, which may function as a fulcrum, such that catch 205 rises and overlaps lower lip 212. Catch 205 may then snap into place against lower lip 212, thus securing wire clip 201 to frame 210. Wire clip 201 may also disconnect from, or disengage from, frame 210 as follows. Force may be applied to inner surface 220. This may cause (i) first portion 206 and second portion 218 to flex and (ii) catch 205 to slide up lower lip 212 and away from groove 211 until it “unsnaps” from lower lip 212, thus disengaging the wire clip 201 from the groove 211.

It is to be understood herein that the flexing of the wire clip may mean any or all of the flexing of first portion 106, second portion 118, both the first and second portions 106 and 118, or the connection point where first and second portions 106 and 118 intersect with one another. In addition, “flexing” as used herein may involve flexing, pivoting, rotating or any other deformation of the wire clip.

Referring now to FIG. 2B, a perspective view of wire clip 201 is shown connected to frame 201, as also shown in cut away view in FIG. 2A.

Referring now to FIG. 3, a cut away view of a wire clip such as wire clip 301 is shown, connecting to a frame such as frame 310 and wires such as wires 315A-C. Wire clip 301 may be like wire clips 101 and 201 as shown and described regarding FIG. 1 and FIG. 2A respectively and others. Wire clip 301 may include a brace 302, a trigger 303, a tab 304, and a catch 305 with an inner surface 320 as shown and described regarding FIG. 3. Wire clip 301 may further include a first portion 306, a slot 309 a flange 316, two or more gathers 317A-317E, a panel 318, and one or more wire channels 307A-307C with apertures 308A-308C, as also shown in FIG. 3. Furthermore, all as shown and described regarding FIG. 2A and others, brace 302 may be similar to brace 202, trigger 303 may be similar to trigger 203, tab 304 may be similar to tab 204, catch 305 may be similar to catch 205, first portion 306 may be similar to catch 206, wire channel 307A-307C may be similar to wire channel 207A-207C, aperture 308A-308C may be similar to aperture 208A-208C, slot 309 may be similar to slot 209, flange 316 may be similar to flange 216, gather 317A-317E may be similar to gather 217A-217E, eyelet 319A-319B may be similar to eyelet 219A-219B, and second portion 318 may be similar to second portion 218. Frame 310 may be similar to frame 210 as shown and described referring FIG. 2A. Wire clip 301 may engage wires 315A-B as follows. First wire clip 301 engages frame 310 in the same or similar manner as wire clip 201 engages frame 210, as described above. Next, a wire such as wire 315A is pressed into an aperture such as 308A such that either or both of gathers 317A and 317B flex, thereby permitting wire 315A to enter wire channel 307A. Alternatively, (i) a wire, such as wire 315B is pressed into an aperture such as 308B such that either or both of gathers 317B and 317C may flex, thereby permitting wire 315B to enter wire channel 307B or (ii) a wire such as wire 315C is pressed into an aperture such as 308C such that either or both of gathers 317D and 317E (not shown) may flex, thereby permitting wire 315C to enter wire channel 307C. The foregoing does not limit the number of wires or similar components and the like that may enter any wire channel 307A-307C. Wire channels such as wire channels 307A-307C may hold wires or similar components. Where wire channels 307A-307C hold wires, those wires may be wires for alternating current (AC), direct current (DC) or another form of transmission as known to one of skill in the art. Furthermore, the trigger 303, panel 318, and gathers 317A-317E may assist regarding wire attachment. An installer may, without limitation, place a thumb against panel 318 and a finger around the concave portion of trigger 303 and then move the wire clip beneath the PV module. An installer may then catch wires 315A-315C or other components against the gathers 317A-317E and pull them back toward the frame for subsequent installation.

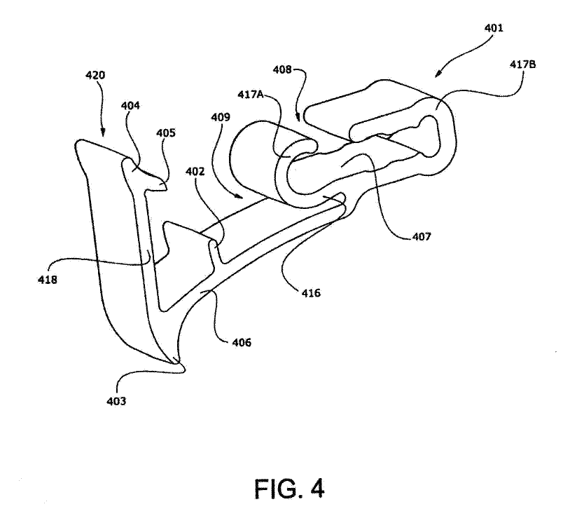

Referring now to FIG. 4, another embodiment of a wire clip such as wire clip 401 is shown. Wire clip 401 is similar to (i) wire clip 101 as shown and described regarding FIG. 1 and others, (ii) wire clip 201 as shown and described regarding FIG. 2A and others, and (iii) wire clip 301 as shown and described regarding FIG. 3. Wire clip 401 may include a brace 402, a trigger 403, a tab 404 with an inner surface 420, and a catch 405 as shown and described regarding FIG. 4. Wire clip 401 may further include a first portion 406, a slot 409, a flange 416, two or more gathers 417A-B, a second portion 418, and one or more wire channels 407 with one or more apertures 408.

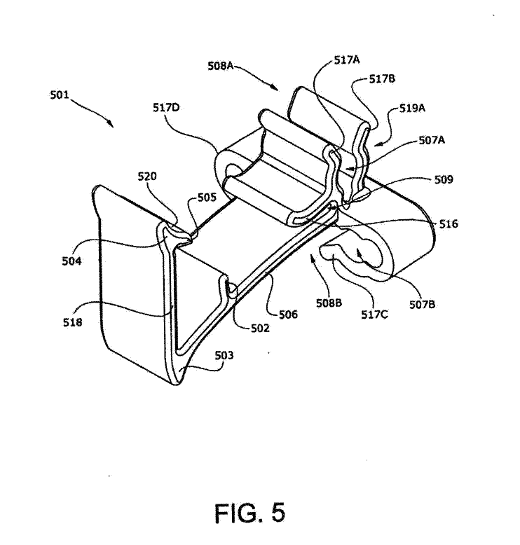

Referring now to FIG. 5, another embodiment of a wire clip such as wire clip 501 is shown. Wire clip 501 is similar to (i) wire clip 101 as shown and described regarding FIG. 1 and others, (ii) wire clip 201 as shown and described regarding FIG. 2A and others, (iii) wire clip 301 as shown and described regarding FIG. 3, and (iv) wire clip 401 as shown and described regarding FIG. 4. Wire clip 501 may include a brace 502, a trigger 503, a tab 504 with an inner surface 520, apertures 508 and a catch 505 as shown and described regarding FIG. 5. Wire clip 501 may further include a first portion 506, a slot 509, a flange 516, two or more gathers 517A-517B, a second portion 518, and one or more wire channels 507 with one or more apertures 508.

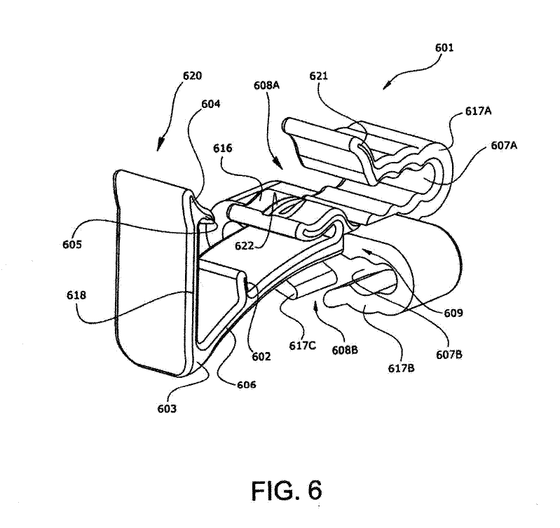

Referring now to FIG. 6, another embodiment of a wire clip such as wire clip 601 is shown. Wire clip 601 is similar to (i) wire clip 101 as shown and described regarding FIG. 1 and others, (ii) wire clip 201 as shown and described regarding FIG. 2A and others, (iii) wire clip 301 as shown and described regarding FIG. 3, (iv) wire clip 401 as shown and described regarding FIG. 4, and (v) wire clip 501 as shown and described regarding FIG. 5. Wire clip 601 may include a brace 602, a trigger 603, a tab 604 with an inner surface 620, and a catch 605. Wire clip 601 may further include a first portion 606, a slot 609, a flange 616, two or more gathers 617A-617B, a second portion 618, and one or more wire channels 607 with one or more apertures 608.

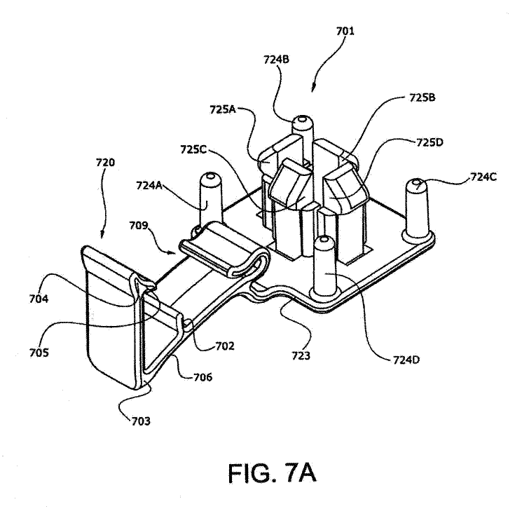

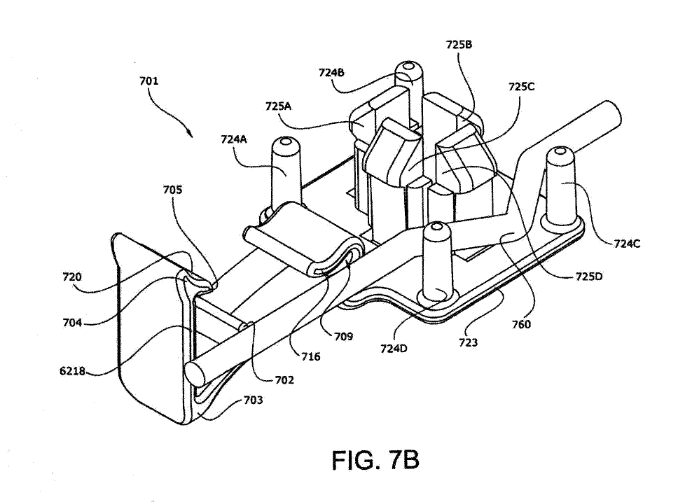

Referring now to FIGS. 7A and 7B, another embodiment of a wire clip such as wire clip 701 is shown. Wire clip 701 is similar to (i) wire clip 101 as shown and described regarding FIG. 1 and others, (ii) wire clip 201 as shown and described regarding FIG. 2A and others, (iii) wire clip 301 as shown and described regarding FIG. 3, (iv) wire clip 401 as shown and described regarding FIG. 4, (v) wire clip 501 as shown and described regarding FIG. 5 and (vi) wire clip 601 as shown and described regarding FIG. 6. Wire clip 701 may include a brace 702, a trigger 703, a tab 704 with an inner surface 720, and a catch 705. Wire clip 701 may further include a first portion 706, a slot 709, and a second portion 718.

Wire clip 701 also includes a platform 723, pins 724A-724D, and hooks 725A-725D. Platform 723 extends from the arm 706 in the opposite direction as the trigger 703. Platform 723 may be formed into a triangular, quadrilateral, circular, or other regular or irregular geometric shape. Pins 724A-724D extend upward from the platform 723 and are arranged such that from a top down view the pins may define the four corners of a square or rectangle centered on platform 723. The pins 724A-724D may be the same size or varying sizes, so various embodiments may include pins of different heights, angles, and/or diameters. Hooks 725A-725C are arranged in a square or rectangle in the center of the platform 723 such that they may face outward toward the perimeter of the platform 723.

Wire clip 701 may engage a groove in the same fashion as wire clip 101 and others as described above. Like wire clip 301 and others, wire clip 701 may orient, organize, and restrict wires and/or other components, but does so as follows. A hook 725D may be pressed toward the center of the platform and held. A wire may then be placed on the platform such that one side of the wire contacts the hook 725D and the other side of the wire, at different locations along its length, contacts an inner surface of pin 724C and 724D. Hook 725D may then be released. Friction may prevent the wire(s) from moving laterally, and the overhang of hook 725D prevents the wire from moving vertically out of wire clip 701.

As seen in FIG. 7B, hooks 725A-725C may flex or otherwise deform to hold a wire 760, as shown. The hooks 725A-725C and pins 724A-724D may be made of different shapes and sizes to accommodate different wire dimensions.

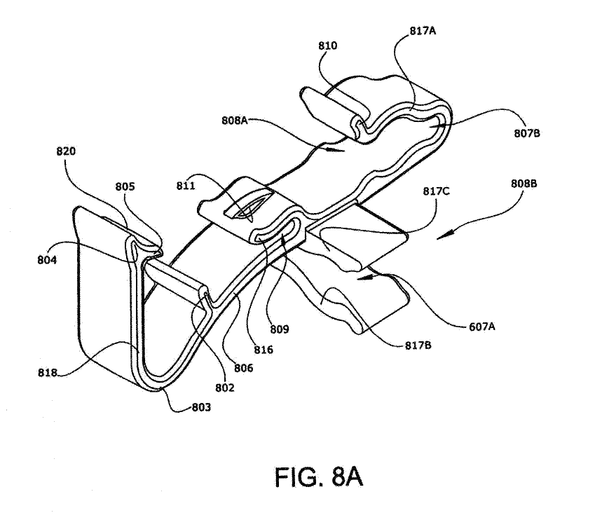

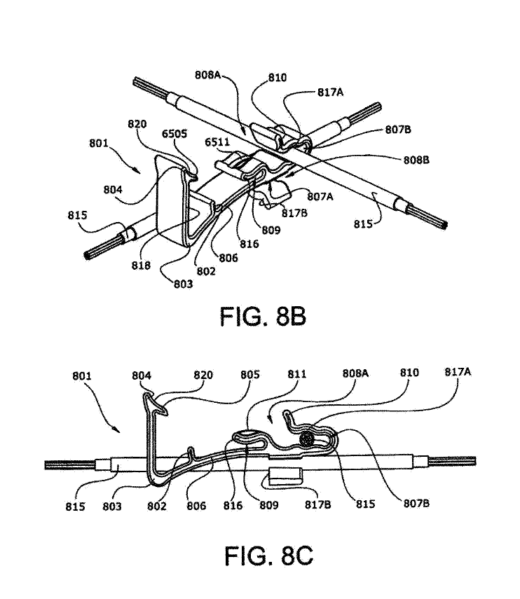

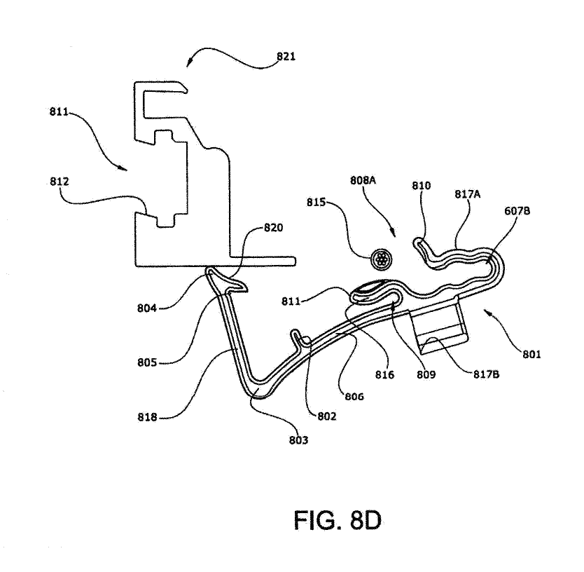

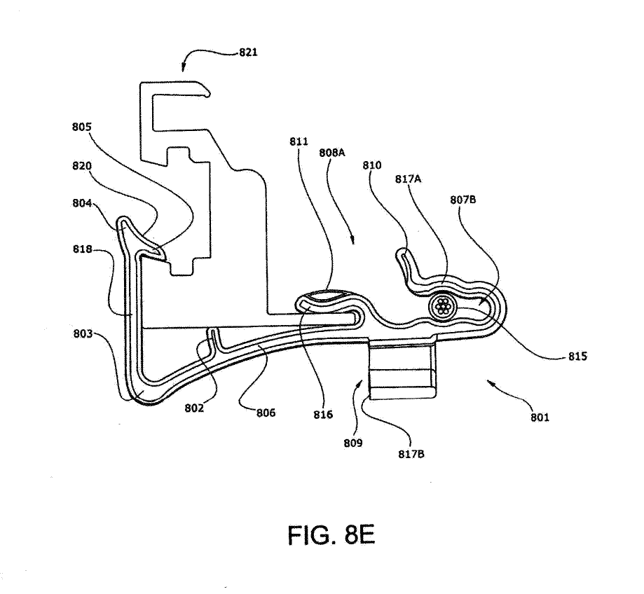

Referring now to FIG. 8A, wire clip 801 has a first portion 806, a second portion 818, brace 802, catch 805, frame receiving slot 809, tab 804, inner surface 820, trigger 803, and wire gathers 808A and 808B (which hold wires in perpendicular directions). First wire gather 808A includes an upper tab 810, perpendicular wire gather 817A and 817B, forming apertures 808A and 807B. Second gather 808B includes a wire receiving aperture 817C. As seen in the perspective view of FIG. 8B and the side elevation view of FIG. 8C, a pair of wires 815 are held in perpendicular orientation to one another.

FIGS. 8D and 8E show sequential steps in the connection of wire clip 801 onto a side of a PV module frame, holding a wire therein, as follows. First, in FIG. 8D, the wire clip is positioned below frame 821, with wire 815 shown. Next, an operator pushes wire clip 810 upwardly such that tab 804 pushes against the bottom of frame 821. By pushing upwardly on trigger 803, with the top of brace 802 sitting against the bottom of the PV module frame, the wire clip will flex such that catch 805 moves away (i.e.: spreads apart) from the opposite end of the wire clip. For example, tab 804 is moved away from the wire gathers 817 and the frame-receiving slot 816 when the wire clip is flexed. Next, as seen in FIG. 8B, the wire clip has been pushed upwardly from below to a position such that catch 805 clips into the open side groove 811 in the PV module frame. Specifically, catch 805 will sit against surface 812 on the bottom of the module side groove. As can be seen, wire 815 will be held in a direction parallel to the side groove 811 in the module.

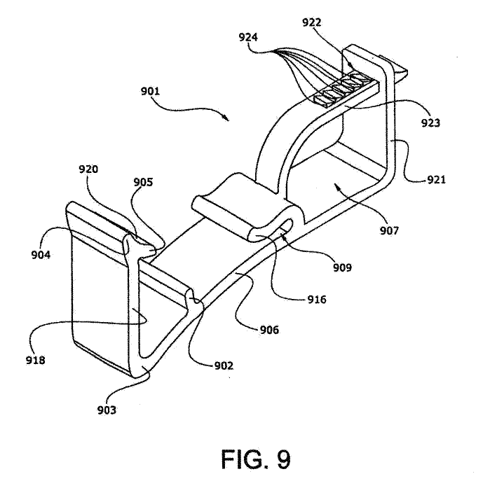

FIG. 9 shows yet another embodiment of the wire clip. Specifically, wire clip 901 has elements operating similarly to elements of the same name (and corresponding number) in previously described embodiments. Wire clip 901 has a first portion 906, a second portion 918, brace 902, catch 905, frame receiving slot 909, tab 904, inner surface 920, trigger 903, and wire gather 907. In this embodiment, wire gather 907 includes a strap 923 with teeth 924 thereon, and a slot 922. As strap 923 is inserted further and further into slot 922, successive teeth 924 will lock. Therefore, a plurality of wires can be inserted through aperture 907 and then strap 923 can be pulled to close or shrink the size of the aperture. As such, different numbers of wires can be held securely in position, depending upon the adjusted final size of aperture 907.

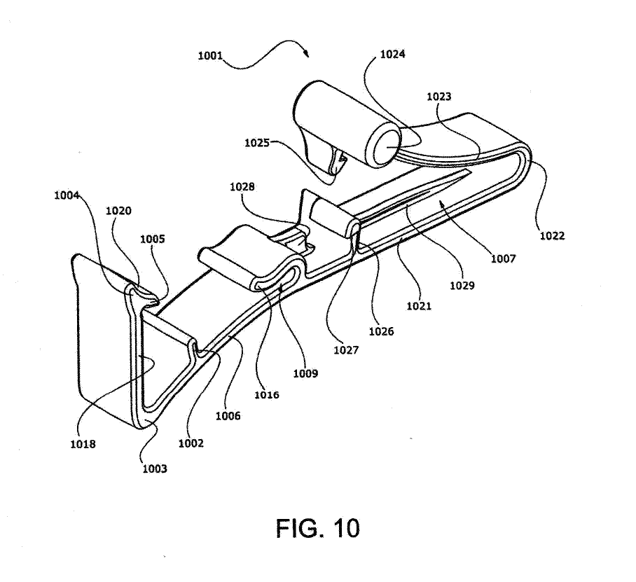

FIG. 10 shows yet another embodiment of the wire clip. Specifically, wire clip 1001 has elements operating similarly to elements of the same name (and corresponding number) in previously described embodiments. Wire clip 1001 has a first portion 1006, a second portion 1018, brace 1002, catch 1005, frame receiving slot 1009, tab 1004, inner surface 1020, trigger 1003, and wire gather 1007. In this embodiment, wire gather 1007 includes a rear arm 1021, spring arm 1023, knob 1024, hook 1025, clasp 1026, rear catch 1027, wire channel 1007, and blocking panel 1028. In operation, knob 1024 is pushed down to snap. An advantage of this design is that it easily holds a plurality of wires in parallel, and permits many wires to be installed at the same time, thereby reducing installer fatigue. It can also hold a wide variety of wire diameters (even at the same time). Advantageously, the wires can be installed after the wire clip itself has been installed.

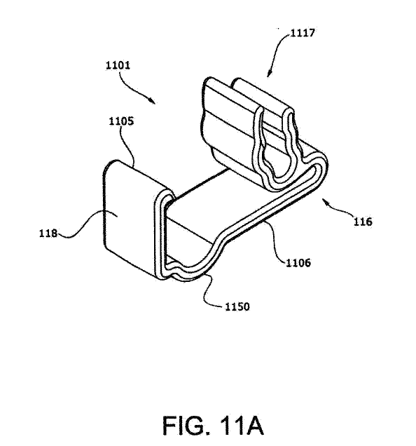

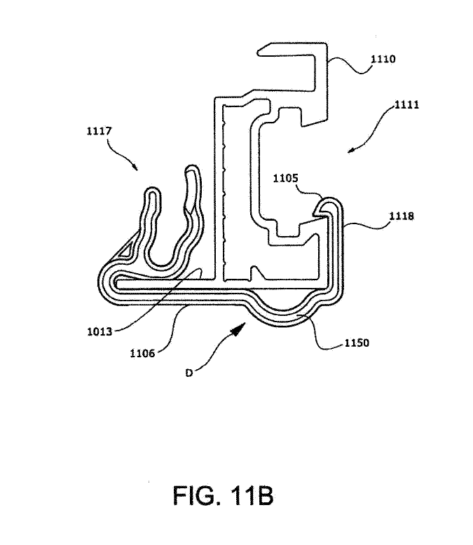

FIG. 11A shows a perspective view of yet another embodiment of a wire clip. Wire clip 1101 has a first portion 1106, a second portion 1118, a frame receiving slot 1116 and a wire gather 1117. However, wire clip 1101 does not have a “brace” similar to element 102 in FIG. 1. Instead, first portion 1106 has a downwardly extending curved portion 1150. Downwardly extending curved portion 1150 operates to permit flexing between first and second portions 1106 and 1118. In addition, downwardly extending curved portion 1150 operates to provide resistance to an installer's finger when the installer pushes along the bottom surface of first portion 1106 towards the end of the device with the second portion 1118.

FIG. 11B shows wire clip 1101 clipped onto the frame 1110 of a PV module frame with catch 1105 snapped into position in groove 1111. As can be seen, the majority of first portion 1106 is parallel to the bottom surface of the PV module frame except for downwardly curved portion 1150 which projects downwardly as a “bump” or “bubble” for the installer's finger to press against (in direction D). A particular advantage of wire clip 1101 is that it can be easily pushed up from below to slip onto the PV module frame. Thus, it is very convenient to use when working on overhead PV module frames. In addition, another advantage of this design is that the wire clip may be installed first, and then the wire(s) added after it is in the installed position. This is because the wire(s) is inserted downwardly (directly towards the bottom ledge of the PV module frame). Thus, inserting the wire(s) downwardly only pushes downwardly on the ledge itself. This pressure does not cause the first and second portions 1106 and 1118 to move or flex with respect to one another. Advantageously as well, the wire(s) are held above the bottom ledge of the PV module frame.

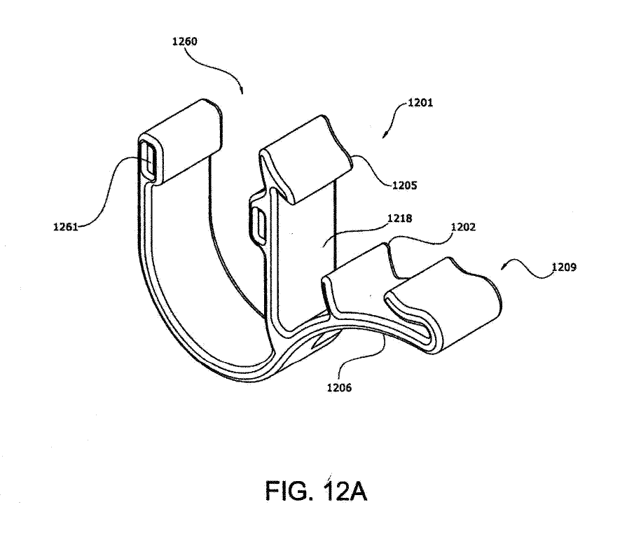

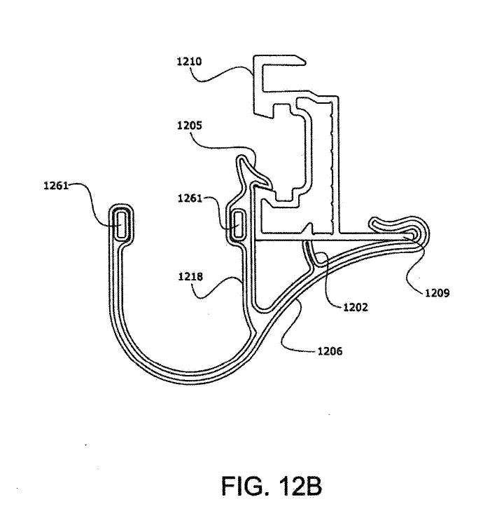

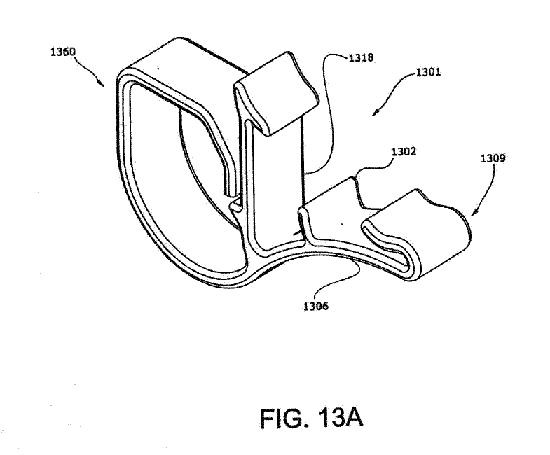

FIG. 12A shows a wire clip 1201 which snaps or clips onto the PV module frame 1210 (in FIG. 12B) similar to how above described wire clip 101 snaps into the PV module frame. Wire clip 1201 has a wire bundle 1260 that can hold a bundle of wires therein. Wire bundle 1260 can be sealed by a connector passing through holes 1261. Wire clip 1201 has a first portion 1206, a second portion 1218, brace 1202, catch 1205, frame receiving slot 1209.

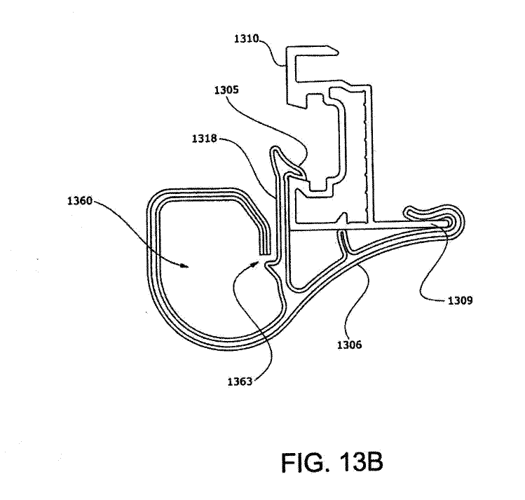

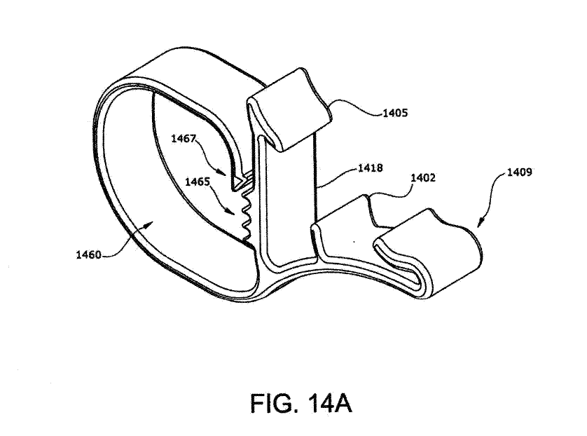

FIG. 13A shows a wire clip 1301 which snaps or clips onto the PV module frame 1310 (in FIG. 13B) similar to how above described wire clip 101 snaps into the PV module frame. Wire clip 1301 has a wire bundle 1360 that can hold a bundle of wires therein. Wire bundle 1360 has an opening at notch 1363. In operation, successive wires can either be inserted through the sides of wire bundle 1360 or be pushed downwardly through the opening at notch 1363. Wire clip 1301 has a first portion 1306, a second portion 1318, brace 1302, catch 1305, and frame receiving slot 1309.

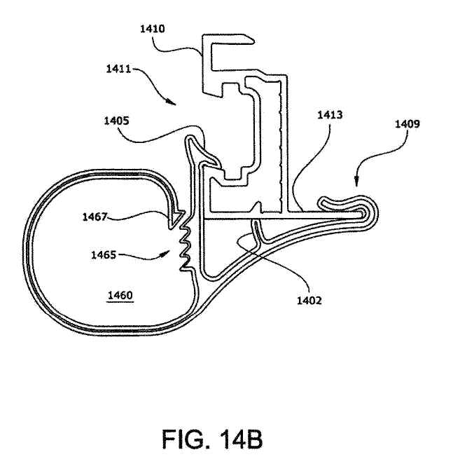

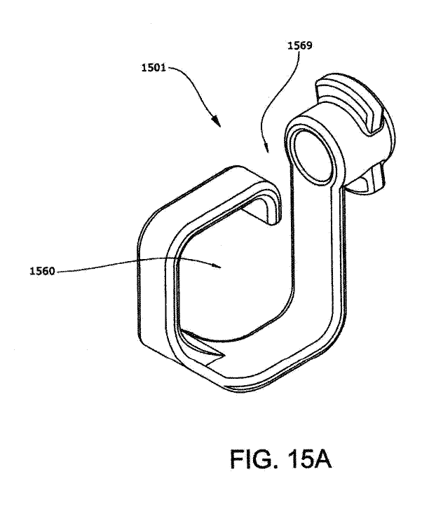

FIG. 14A shows a wire clip 1401 which snaps or clips onto the PV module frame 1410 (in FIG. 14B) similar to how above described wire clip 101 snaps into the PV module frame. Wire clip 1401 has a wire bundle 1460 that can hold a bundle of wires therein. Wire bundle 1460 has an opening with teeth 1465 interlocking with catch 1467. In operation, successive wires can either be inserted through the sides of wire bundle 1460 or be pushed downwardly through the opening between teeth 1465 and catch 1467. Wire clip 1401 has a first portion 1406, a second portion 1418, brace 1402, catch 1405, and frame receiving slot 1409.

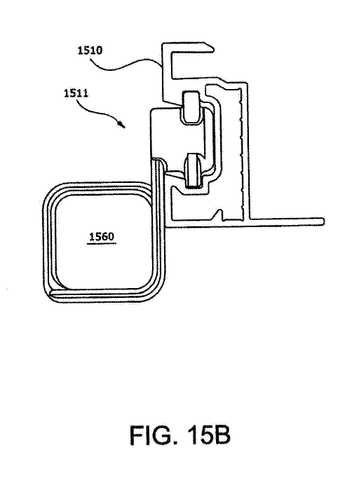

FIG. 15A shows a wire clip 1501 which rotates into a locked position in side groove 1511 in frame 1501. Wire clip 1501 has a wire bundle 1560 that can hold a bundle of wires therein. Wire bundle 1560 has a spiral structure forming a side opening 1569. In operation, successive wires can either be inserted through the sides of wire bundle 1560 or be pushed downwardly through the opening 1569.

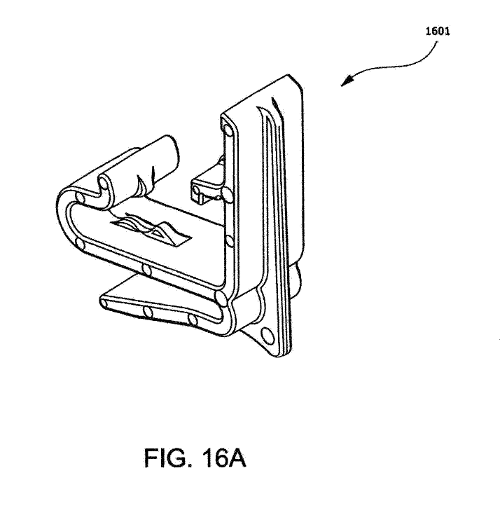

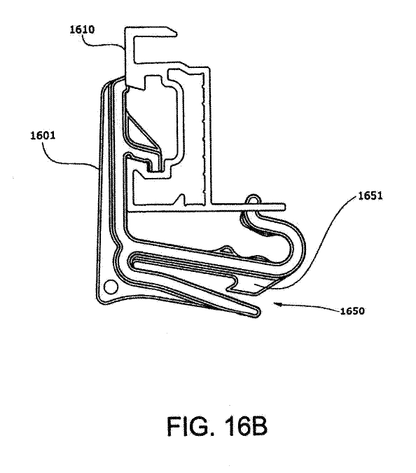

FIG. 16A shows a wire clip 1601. Wire clip 1601 snaps into groove 1611 in PV module frame 1610, as shown. Wire clip 1611 is ideally suited to support the edge of a pest abatement screen (not shown) that is received into channel 1650 (and held in place by barb 1651.

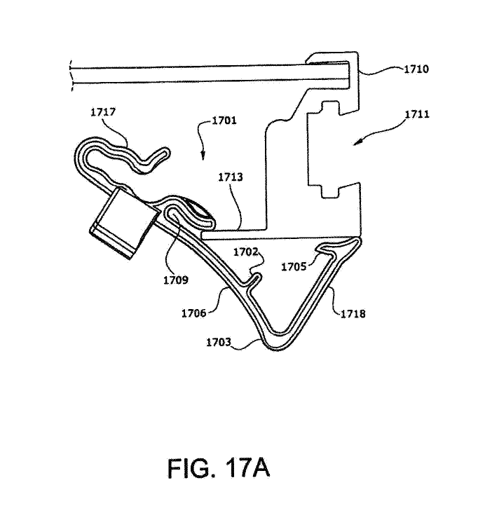

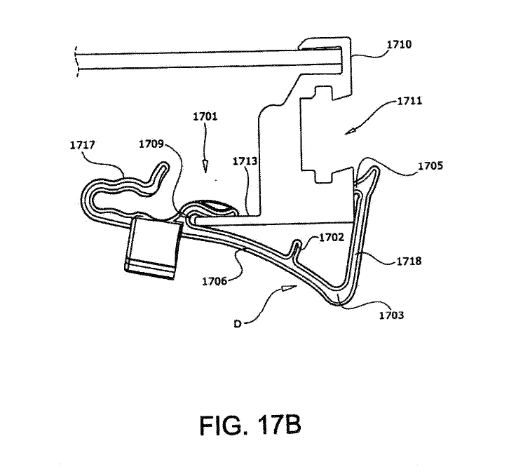

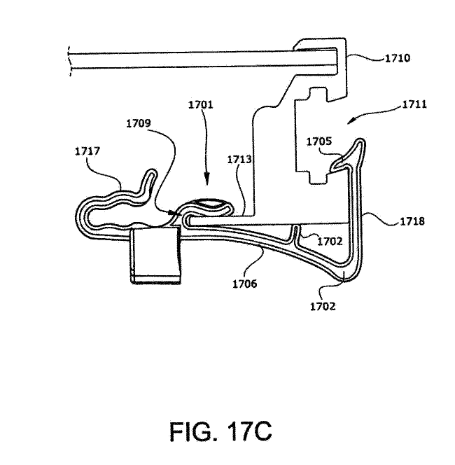

Lastly, FIGS. 17A to 17C show successive steps in the snapping or clipping into position of the embodiment of the wire clip described in FIGS. 8A to 8D. First, as seen in FIG. 17A, wire clip 1701 is positioned such that lower frame element (i.e.: ledge) 1713 is about to be inserted into frame-receiving slot 1709. Next, as seen in FIG. 17B, an installer pushes upwardly against the trigger portion 1703 in direction D. At this time, the end of brace 1702 will contact (and push against) the bottom surface of the frame. Also, catch 1705 will slide upwardly against the side edge of frame 1710. Thus, FIG. 17B illustrates the wire clip flexing. Part of such flexing involves catch 1705 being pulled away from slot 1709. First and second portions 1706 and 1718 slightly angle away from one another at this time, spreading apart as the wire deforms to fit around the lower portion of the PV module frame. Finally, as seen in FIG. 17C, catch 1705 snaps into position in groove 1711. Preferably, this snapping action is audible such that the installer knows that wire clip 1701 is correctly secured into position.

1. A flexible wire clip dimensioned to be attached into a side groove on a photovoltaic module frame, comprising:
a first portion;
a frame-receiving slot at a first end of the first portion;
a brace extending upwardly from the first portion;
a wire gather on the first portion; and
a second portion extending upwardly from a second end of the first portion; and
a catch on the second portion,
wherein the wire clip flexes during installation such that the catch moves away from the frame-receiving slot and slides upwardly against a side edge of the photovoltaic module frame so that a frame member of a photovoltaic module frame can be inserted into the frame-receiving slot, and wherein the wire clip returns to a substantially non-flexed position after installation such that the catch is received within a side groove on a photovoltaic module frame, with the brace being positioned against a bottom surface of the photovoltaic module frame.

2. The wire clip of claim 1, wherein the catch snaps into the side groove on a photovoltaic module frame during installation, thereby producing an audible sound.

3. The wire clip of claim 1, wherein the first portion is curved downwardly and the second portion extends upwardly from the first portion.

4. The wire clip of claim 3, wherein a bottom surface of the first portion is curved downwardly to form a trigger, and wherein force applied to the trigger causes the wire clip to flex during installation.

5. The wire clip of claim 1, wherein the bottom surface of the first portion is curved downwardly away from the frame of the photovoltaic module frame after installation.

6. The wire clip of claim 1, wherein both the first and second portions flex during installation.

7. The wire clip of claim 1, wherein the wire clip flexes around the end of the brace that contacts the bottom surface of the photovoltaic module frame.

8. The wire clip of claim 1, further comprising:
an unclipping tab at an end of the second portion near the catch, wherein force applied downwardly to the unclipping tab causes the wire clip to flex thereby unclipping the catch from the side groove in the photovoltaic module frame.

9. The wire clip of claim 1, further comprising a deformable wire channel disposed in the gather.

10. The wire clip of claim 1, further comprising an eyelet disposed in the gather.

11. The wire clip of claim 1, wherein the frame-receiving slot is formed at a base of the at least one gather.

12. The wire clip of claim 1, wherein different wire gatherers hold different wires at different vertical heights.

13. The wire clip of claim 1, wherein different wire gatherers hold different wires at different angles to one another.

14. The wire clip of claim 1, wherein the wire gather is positioned above the frame-receiving slot such that a wire received therein is positioned above a bottom surface of the photovoltaic module frame.

15. The wire clip of claim 1, wherein the first portion is not parallel to the frame member inserted into the frame-receiving slot after the wire clip returns to the substantially non-flexed position after installation.

16. The wire clip of claim 1, wherein the wire gather is a wire bundle holder.

17. A flexible wire clip dimensioned to be attached into a side groove on a photovoltaic module frame, comprising:
a downwardly curved first portion;
a frame-receiving slot at a first end of the first portion;
a brace extending upwardly from the first portion;
a wire gather on the first portion; and
a second portion extending upwardly from a second end of the first portion; and
a catch on the second portion,
wherein the wire clip flexes during installation such that the catch moves away from the frame-receiving slot and slides upwardly against a side edge of the photovoltaic module frame so that a frame member of a photovoltaic module frame can be inserted into the frame-receiving slot, and
wherein the wire clip returns to a substantially non-flexed position after installation such that the catch is received within a side groove on a photovoltaic module frame, and the brace is positioned against a bottom surface of the photovoltaic module frame, and
wherein the bottom surface of the first portion is curved downwardly away from the frame to form a trigger, and wherein force applied to the trigger causes the wire clip to flex during installation.

18. The wire clip of claim 17, wherein the first portion is not parallel to the frame member of a photovoltaic module frame inserted into the frame-receiving slot after the wire clip returns to the substantially non-flexed position after installation.

19. A method of clipping a wire clip into a side groove on a photovoltaic module frame, comprising:
(a) providing a wire clip having:
a first portion;
a frame-receiving slot at a first end of the first portion;
a brace extending upwardly from the first portion;
a wire gather on the first portion; and
a second portion extending upwardly from a second end of the first portion; and
a catch on the second portion;
(b) inserting a frame member of a photovoltaic module frame into the frame-receiving slot;
(c) positioning the brace against a bottom surface of the frame member;
(d) applying a force to the bottom of the first portion, thereby causing the wire clip to flex such that the catch moves away from the frame-receiving slot and slides upwardly against a side edge of the photovoltaic module frame until the catch snaps into a side groove on a photovoltaic module frame and the wire clip returns to a substantially non-flexed position.

20. The method of claim 19, wherein the force applied to the bottom of the first portion is applied at the end of the first portion from which the second portion extends.

21. The method of claim 19, wherein the first portion is downwardly curved and the second portion extends from the first portion at an acute angle.

22. A flexible wire clip dimensioned to be attached into a side groove on a photovoltaic module frame, comprising:
a first portion;
a frame-receiving slot at a first end of the first portion;
a wire gather on the first portion; and
a second portion extending upwardly from a second end of the first portion; and
a catch on the second portion,
wherein the wire clip flexes during installation such that the catch moves away from the frame-receiving slot and slides upwardly against a side edge of the photovoltaic module frame so that a frame member of a photovoltaic module frame can be inserted into the frame-receiving slot, and
wherein the wire clip returns to a substantially non-flexed position after installation such that the catch is received within a side groove on a photovoltaic module frame, with the brace being positioned against a bottom surface of the photovoltaic module frame, and
wherein the first portion includes a downwardly extending curved portion that permits the first and second portions to flex with respect to one another.

23. The wire clip of claim 22, wherein both the first and second portions flex during installation.

24. The wire clip of claim 22, further comprising:
an unclipping tab at an end of the second portion near the catch, wherein force applied downwardly to the unclipping tab causes the wire clip to flex thereby unclipping the catch from the side groove in the photovoltaic module frame.

25. The wire clip of claim 22, further comprising a deformable wire channel disposed in the gather.

26. The wire clip of claim 22, further comprising an eyelet disposed in the gather.

27. The wire clip of claim 22, wherein the frame-receiving slot is formed at a base of the at least one gather.

28. A method of clipping a wire clip into a side groove on a photovoltaic module frame, comprising:
(a) providing a wire clip having:
a first portion;
a frame-receiving slot at a first end of the first portion;
a wire gather on the first portion; and
a second portion extending upwardly from a second end of the first portion; and
a catch on the second portion;
(b) inserting a frame member of a photovoltaic module frame into the frame-receiving slot;
(c) positioning the first portion against a bottom surface of the frame member; while
(d) applying a force to a downwardly extending curved portion of the first portion, thereby causing the wire clip to flex such that the catch moves away from the frame-receiving slot and slides upwardly against a side edge of the photovoltaic module frame until the catch snaps into a side groove on a photovoltaic module frame and the wire clip returns to a substantially non-flexed position.
